(19) United States
(12) Patent Application Publication
(10) Pub. No.: US 2024/0422255 A1
(43) Pub. Date: Dec. 19, 2024

(54) CELLULAR CHIPSET EMBEDDED UNDER SCALP

(71) Applicant: Philip Kennedy, Kennedy, GA (US)

(72) Inventor: Philip Kennedy, Kennedy, GA (US)

(21) Appl. No.: 18/701,466

(22) PCT Filed: Oct. 13, 2022
(86) PCT No.: PCT/US2022/046599

§ 371 Date: Apr. 15, 2024

Related U.S. Application Data
(60) Provisional application No. 63/257,362, filed on Oct. 19, 2021.

(51) Int. Cl. H04M 1/05; H04R 1/02; H04R 1/08; H04R 3/00

(52) U.S. Cl. CPC H04M 1/05; H04R 1/025; H04R 1/08; H04R 3/00; H04R 2420/07

(57) ABSTRACT

A communicating device (100) for a user having a scalp (10) and a skull bone (12). A microphone (120) embedded between the scalp (10) and the skull bone (12) senses from the skull bone (12) user-generated sound vibrations and generates a first electrical signal representative thereof. A speaker (130) embedded between the scalp (10) and a skull bone transmits received sound vibrations to the skull bone (12) in response to a second electrical signal. The received sound vibrations are sensed by the user. A chipset (110) embedded between the scalp (10) and a skull bone (12) of the user is electrically coupled to the microphone (120) so as to receive the first electrical signal and is electrically coupled to the speaker (130) so as to generate the second electrical signal. The chipset (110) includes a circuit that is configured to communicate with a remote wireless communication device (14).

### CROSS-REFERENCE TO RELATED APPLICATION(S)

This application claims the benefit of U.S. Provisional Patent Application Ser. No. 63/257,362, filed Oct. 19, 2021, the entirety of which is hereby incorporated herein by reference.

### 1. FIELD OF THE INVENTION

The present invention relates to interpersonal communications systems and, more specifically, to a communications system for being embedded under a user's scalp.

### 2. DESCRIPTION OF THE RELATED ART

Cellular telephones are quite common throughout the world. Some uses of cellular telephones require hands-free operation. In such cases, users typically employ “ear buds” employing local network technology such as “BlueTooth.” Such devices have in-ear speakers and a microphone that send and receive sound data to and from a cellular telephone. However, for some highly active people, such as military members, emergency responders and athletes, the use of cellular telephone/ear bud combinations can be burdensome.

Therefore, there is a need for a device that frees individuals from having to carry a cellular telephone and wear ear buds.

### SUMMARY OF THE INVENTION

The disadvantages of the prior art are overcome by the present invention which, in one aspect, is a communicating device for a user having a scalp and a skull bone. A microphone is embedded between the scalp and the skull bone of the user so as to sense user-generated sound vibrations corresponding to verbal sounds and other sounds generated by the user from the skull bone and to generate a first electrical signal representative thereof. A speaker is embedded between the scalp and a skull bone of the user so as to transmit received sound vibrations to the skull bone in response to a second electrical signal. The received sound vibrations are sensed by the user. A chipset is embedded between the scalp and a skull bone of the user. The chipset is electrically coupled to the microphone so as to receive the first electrical signal and is electrically coupled to the speaker so as to generate the second electrical signal. The chipset includes a circuit that is configured to communicate with a remote wireless communication device.

In another aspect, the invention is a communicating system. A microphone is configured to sense user-generated sound vibrations from a skull bone corresponding to verbal sounds and other sounds generated by a user and to generate a first electrical signal representative thereof. A speaker is configured to transmit received sound vibrations to the skull bone in response to a second electrical signal. The received sound vibrations are sensed by the user. A chipset is electrically coupled to the microphone so as to receive the first electrical signal therefrom and is electrically coupled to the speaker so as to generate the second electrical signal. The chipset includes a circuit that is configured to communicate with a remote wireless communication device. A biocompatible envelope is disposed around the microphone, the speaker and the chipset. A battery powers the chipset and is rechargeable by a wireless power transfer device. When the biocompatible envelope is embedded between a scalp and the skull bone of a user, the microphone is disposed in a position to sense the user-generated sound vibrations and the speaker is disposed in a position to transmit received sound vibrations to the skull bone.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram showing one embodiment of the invention.

FIG. 2 is a schematic diagram showing an embodiment corresponding to in greater detail.

FIG. 3 is a schematic diagram showing a unitary embodiment.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

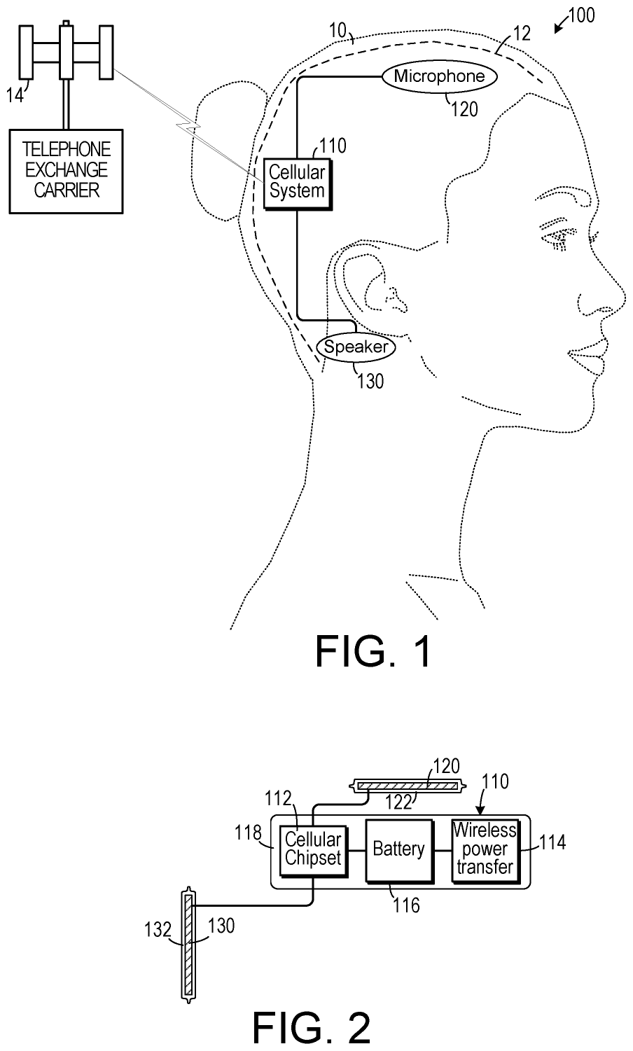

As shown in FIG. 1, one embodiment of the invention is a communicating system 100 that includes a combination of a cellular system 110, a microphone 120 and a speaker 130 embedded between the scalp 10 and the skull bone 12 of a user. The microphone 120 is configured to sense sounds (such as verbal sounds and other sounds) made by the user. (In addition to verbal sounds, certain non-verbal sounds, such as clicking, tapping, etc., may also be sensed by the microphone.) In one embodiment, the sounds are sensed through contact with the user's skull bones, such as the frontal or parietal bones. The speaker 130 is typically placed near an ear, such as at the temporal bone of the skull. The placement of these items, as shown in FIG. 1, is given as an example and it is understood that many other placements can be employed without departing from the scope of the invention. The cellular system 110 communicates with a cellular telephone tower 14. In use, when the user talks, the microphone 120 detects the sound, which the cellular system 110 sends to the tower 14. When a communication is received from the tower 14, the cellular system 110 sends it to the speaker 130, which transmits it securely to the user's ear via the skull bone.

As shown in FIG. 2, the microphone 120 is surrounded by a biocompatible envelope 122. Similarly, the speaker 130 is also surrounded by a biocompatible envelope 132. The cellular system 110 includes a cellular chipset 112 that is powered by a battery 116. The battery 116 can be recharged periodically via a wireless power transfer system 114. The cellular chipset 112, the battery 116 and wireless power transfer system 114 are also surrounded by a biocompatible envelope 118. The biocompatible envelopes could include materials such as a polyamide, polytetrafluoroethylene-which is sold under the mark Teflon®, or a poly (p-xylylene) polymer-which sold under the mark Parylene®. These materials are given as examples only and other materials can be used in certain embodiments.

To implant the system, a surgeon would make an incision at the site of the microphone 120, the speaker 130, the cellular system 110 and the connecting wires. Subcutaneous tissue at these sites can be removed to make room for these components. The incision is closed and allowed to heal. When the system is no longer needed, the components can be removed.

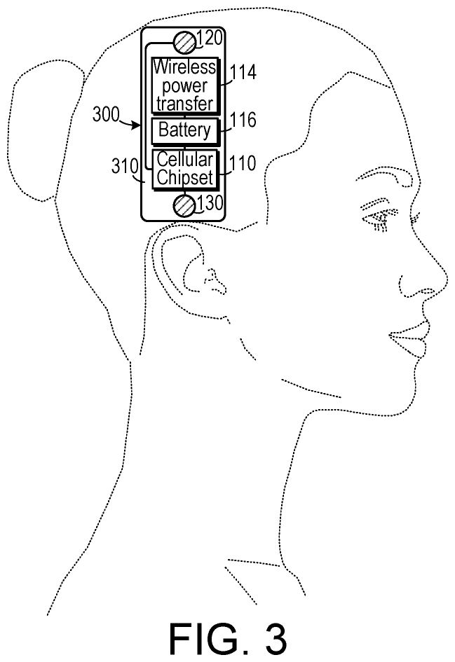

As shown in FIG. 3, the system 300 can be made as a unitary system in which all of the components and wiring are enclosed in a single biocompatible envelope 310. Such a configuration could make implantation simpler.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112 (f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A communicating device for a user having a scalp and a skull bone, comprising:
(a) a microphone embedded between the scalp and the skull bone of the user so as to sense user-generated sound vibrations corresponding to sounds generated by the user from the skull bone and to generate a first electrical signal representative thereof;
(b) a speaker embedded between the scalp and a skull bone of the user so as to transmit received sound vibrations to the skull bone in response to a second electrical signal, wherein the received sound vibrations are sensed by the user; and
(c) a chipset embedded between the scalp and a skull bone of the user, the chipset electrically coupled to the microphone so as to receive the first electrical signal and electrically coupled to the speaker so as to generate the second electrical signal, the chipset including a circuit that is configured to communicate with a remote wireless communication device.

2. The communicating device of claim 1, wherein the chipset comprises a cellular chipset and wherein the remote wireless communication device comprises a cellular telephone tower.

3. The communicating device of claim 1, further comprising:
(a) a battery that powers the chipset; and
(b) a wireless power transfer device embedded between the scalp and a skull bone that recharges the battery.

4. The communicating device of claim 1, wherein the microphone is surrounded by a biocompatible envelope.

5. The communicating device of claim 4, wherein the biocompatible envelope comprises at least one of polyamide, polytetrafluoroethylene, or a poly (p-xylylene) polymer.

6. The communicating device of claim 1, wherein the speaker is surrounded by a biocompatible envelope.

7. The communicating device of claim 6, wherein the biocompatible envelope comprises at least one of polyamide, polytetrafluoroethylene, or a poly (p-xylylene) polymer.

8. The communicating device of claim 1, wherein the microphone is placed adjacent to a selected one of a frontal bone or a parietal bone of the skull bone.

9. The communicating device of claim 1, wherein the speaker is placed adjacent to a temporal bone of the skull bone.

10. The communicating device of claim 1, wherein the sounds comprise verbal sounds.

11. A communicating system, comprising:
(a) a microphone configured to sense user-generated sound vibrations from a skull bone corresponding to sounds generated by a user and to generate a first electrical signal representative thereof;
(b) a speaker configured to transmit received sound vibrations to the skull bone in response to a second electrical signal, wherein the received sound vibrations are sensed by the user;
(c) a chipset that is electrically coupled to the microphone so as to receive the first electrical signal therefrom and electrically coupled to the speaker so as to generate the second electrical signal, the chipset including a circuit that is configured to communicate with a remote wireless communication device; and
(d) a biocompatible envelope disposed around the microphone, the speaker and the chipset; and
(e) a battery that powers the chipset the battery being rechargeable by a wireless power transfer device,
wherein when the biocompatible envelope is embedded between a scalp and the skull bone of a user, the microphone is disposed in a position to sense the user-generated sound vibrations and the speaker is disposed in a position to transmit received sound vibrations to the skull bone.

12. The communicating system of claim 11, wherein the chipset comprises a cellular chipset and wherein the remote wireless communication device comprises a cellular telephone tower.

13. The communicating system of claim 11, wherein the biocompatible envelope comprises at least one of polyamide, polytetrafluoroethylene, or a poly (p-xylylene) polymer.

14. The communicating system of claim 11, wherein the microphone is placed within the biocompatible envelope so as to be adjacent to a selected one of a frontal bone or a parietal bone of the skull bone when the biocompatible envelope is embedded between the skull bone and the scalp.

15. The communicating system of claim 11, wherein the speaker is placed within the biocompatible envelope so as to be adjacent to a temporal bone of the skull bone when the biocompatible envelope is embedded between the skull bone and the scalp.

16. The communicating system of claim 11, wherein the sounds comprise verbal sounds.
